(19) United States
(12) Patent Application Publication
(10) Pub. No.: US 2009/0006120 A1
(43) Pub. Date: Jan. 1, 2009

(54) Social and/or Business Relations Icebreaker: the use of communication hardware and/or software to safely communicate desires to further advance relations without the fear of being rejected and/or unnecessarily revealing information and/or intentions.

(76) Inventor: Terry Jia-Ming Huang, (US)

Correspondence Address: Terry Huang, 4723 Shadwell Place, San Diego, CA, 92130, US

(21) Appl. No.: 12/138,451

(22) Filed: Jun. 13, 2008

Related U.S. Application Data
(60) Provisional application No. 60/943,594, filed on Jun. 13, 2007.

(51) Int. Cl. G06Q 10/00; G06F 17/30

(52) U.S. Cl. 705/1

(57) ABSTRACT

Even in this Web 2.0 era, social networking channels fail to address an essential issue; that is the fear of being rejected. Likewise, business relations suffer from the flood of spam emails and junk mails. The lack of safe and quality exchange of information has hindered the progress of positive business relations. This invention involves a new use of currently available web and communication technologies. New inventions we commonly see try to build up methodologies to increase the quality of information about members in a social network. They try to locate members of the like interest real time using global positioning technologies. All these efforts try to expand relations to the unknown world, getting to know people they have never interacted before. My invention targets on people you have seen or acquainted with, or companies you know. Based on the knowledge you have with certain people or companies of interest (“prospects”), this invention provides a safe environment for advancing social and/or business relations. A networked database is being used to facilitate the process. A member's intention to advance relation with a prospect (also one of the network members) will be disclosed to such prospect only when such prospect also intends to advance relation with the member; and only when certain criteria and/or expectations predefined by members are met.

### CROSS REFERENCE TO RELATED APPLICATION

This application claims the benefit of U.S. Provisional Application No. 60/943,594, entitled “Social Networking Icebreaker: the use of communication hardware and/or software to safely communicate desires to further advance relations without the fear of being rejected” and filed on Jun. 13, 2007, the entirety of which is incorporated herein by reference.

### BRIEF SUMMARY OF THE INVENTION

The invention refers to the use of communication hardware and/or software including database application to safely communicate desires to further advance relations without the fear of being rejected and/or unnecessarily revealing information and/or intentions.

Although this invention can be applied to various social and, or business settings, one extreme application can be effectively applied to the courtship between a man and a woman. One can send out a signal/query in favor of an advanced relationship without the other party's knowledge unless the other party happens to send out the same signal/query addressing equal desire to advance the relationship. The signal/query can be sent out via hardware such as a Bluetooth enabled devices or cell phones, among others, or via software such as email/web and database application. In the ,case when mobile phones are used, parties involved do not need to know the other party's phone number. When both parties emit signal/query to the server where databases reside, in favor of an advanced relationship, they both will receive a positive message either right at the time and place the signals/queries are exchanged, or later when they log into their accounts. In the latter case, basic information will be available to both parties for them to arrange further contacting. One of the key factors in a romance is that both parties are being physically attracted by the other party. One may spend a lot of time chatting over the internet and phone before they finally meet and realize that there is no chemical at all. This invention will help dealing with this essential factor as a prospect needs to be identified first, One sends out a message/signal/query inviting a relationship when one sees and is attracted by the other party. Needless to say, the exchange of affections should not be solely based on physical attraction. Criteria should be established in one's account so that favorable return will not result even both parties send out favorable signal/query when their criteria set by themselves do not support their advanced relationship.

Software,/Databases alone can also be used to accomplish the same purpose. One can log on to its account in the website of the service provider, query by a prospect's email address and/or phone number, among others, and address the desire of an advanced relationship with the prospect; however, nothing will be received by the prospect unless the prospect also sends out such favorable desire and that the expectations preset in the databases met. This may be used among acquaintances or even friends. In any case, the amount of information disclosed is well under the users' control. While great romance takes courage, this invention will promote healthy social life of many, while creating a new kind of romance in the new era.

Likewise, sensitive business intentions are better expressed using this invention. Business owners may log on to the database, query a company they have in mind to conduct any businesses they have in mind buying a prospect company for example. If it happens the prospect company also is enrolled in as a member of the network, and has a desire to sell the company, the intentions can be crossed when preset expectations are met. The preset expressions may include whether the prospect company has any debt and that to what extent such buyer can accept. If it turns out some expectations do not meet, the prospect company will not be aware of such intention of the buyer. Instead of soliciting sellers or buyers, this invention provides a safe and quality matching environment.

All other social networking inventions try to find unknown prospects, although in some cases in a network geared to include members of like interests, and geographically approximate. My invention geared to advance relations with known prospects, even in an extreme case of romantic relations when members never met until the moment of encounter. A successful romantic relation will be realized only when both are members, both in a defined time frame and approximate geographic locations (a reasonable distance two persons may actually have seen each other) initiate a query in the networked databases via hand-held wireless device, and receive back positive return when expectations set in the member questionnaires match.

My invention does not require a handheld wireless device most of the time. The followings are only examples: Members can log on to their accounts, type in a person's name and/or email address and/or phone number, etc; or a company name and/or company's website address, etc., you may find an acquaintance in fact matches your expectations and is also interested in advancing relations with you; or a local company you admire is interested in paying you the price you expected and acquire your company. Very valuable relations can happen via my invention. Using the methods in my invention, there is no need to chat with total strangers or sending out junk mails with low success rate.

In comparison with U.S. Pat. No. 7,310,676 (Bourne, Julian J.) where mobile device and a server are used to seek for new prospects; my invention does not always require the use of mobile device; and my invention does not engage in seeking for prospect, rather confirming mutual fits between two parties already have acquainted or encountered.

### BRIEF DESCRIPTION OF THE FIGURES

FIG. 1

These are sample records in a database that shall reside in a server using web interface. Page 1 is an account profile for member “icebreaker” with contact email address iCebreak@email.com. This user has a desire of Dating and Marriage; While expecting a prospect having the desire of Dating OR Marriage. This user's hobbies include Walking and Movie; while expecting a prospect enjoy Reading, Garden and Flower, Waling as well as Movie. This user makes 80,000 a year; while expecting a prospect to make at least 50,000. This user is in Biotech and accepting a prospect to be in any other fields but Biotech. Nothing will happen with just an established account until one day this user think about a college friend and wonder if this friend is interested in dating or marrying this user. This user entered in the field “Prospect eMail” this college friend's email address prosect@email.com (page 1). As it happens that prospect@email.com already is a registered member who also has entered in the field “Prospect eMail” this user's email address icebreaker@email.com (page 2), the database script returns a “Match” result after reviewing their facts and expectations. As you can see by comparing the two records, they do match. The questionnaires can be elaborate or simple depending on users' preference. This figure simply tries to show the mechanisms.

FIG. 2

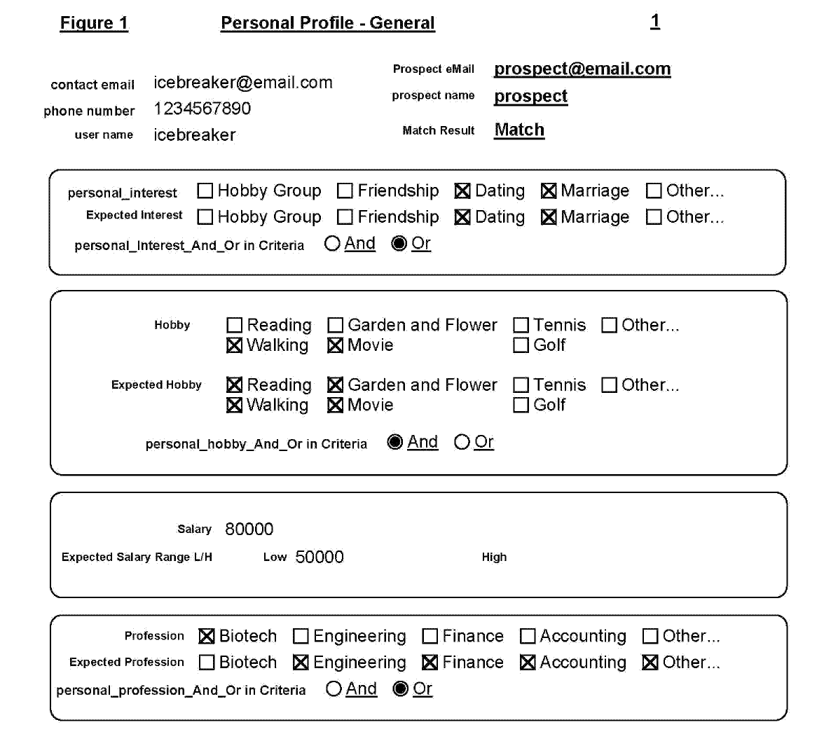

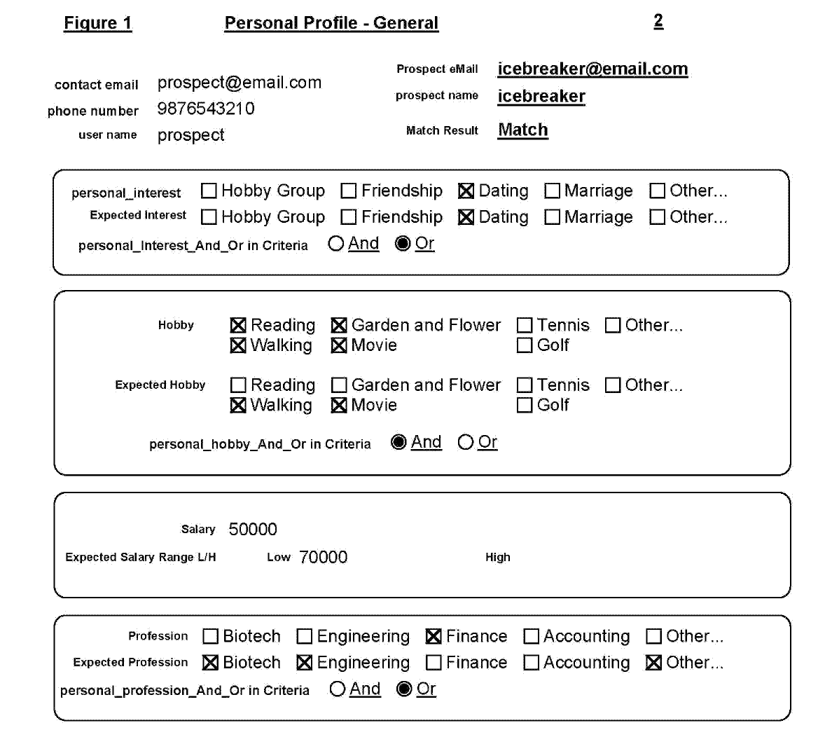

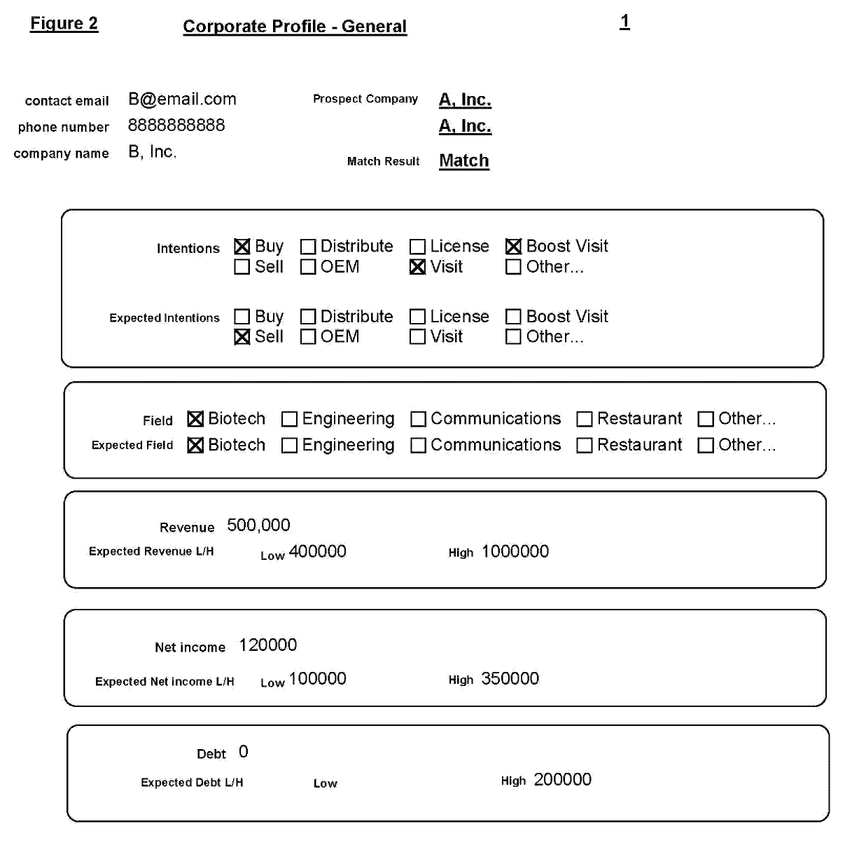

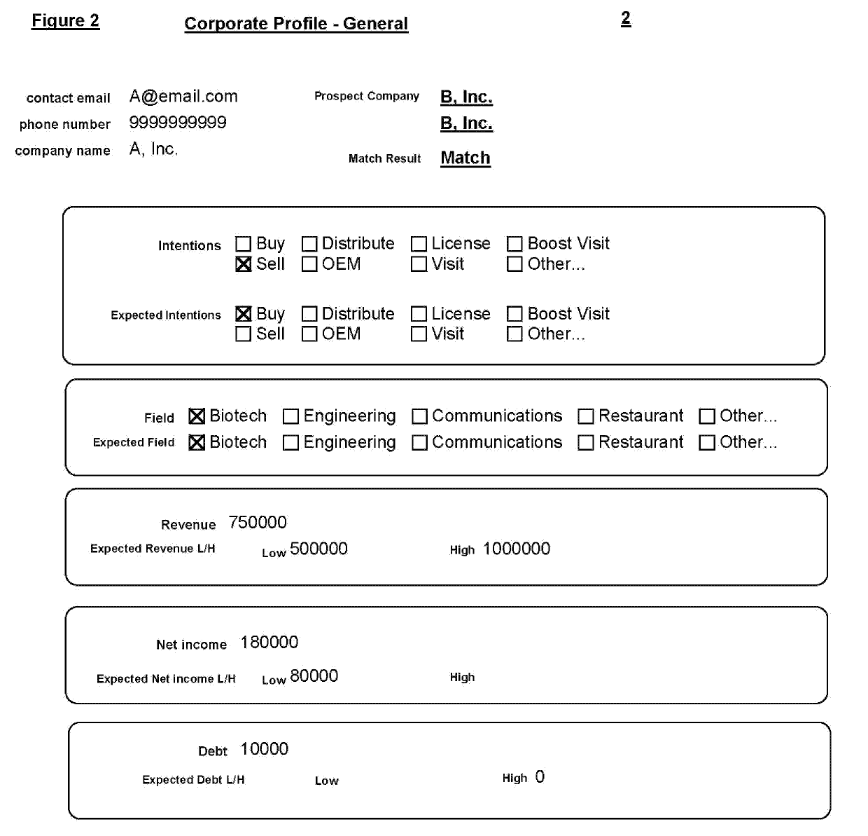

The same mechanism is used as FIG. 1; this FIG. 2 presents a situation in business settings. Company B is interested in buying and visiting a company for sale. Company B is a biotech company; and expects to buy another biotech company. Company B 500,000 in revenue; and expect to buy a company with revenue between 400,000 and 1,000,000. It has net income of 120,000 and the prospect is expected to have a net income of 100,000 to 350,000. It has no debt at all but can accept the prospect to have as much as 20,000 in debt. Nothing happens until Company A comes across the mind of the owner of Company B; and makes a query of Company A by entering “A, Inc.” in the field of “,Prospect Company”. As Company A happens to be in the network with all criteria met mutually, a deal is very likely to happen shortly. Without this invention, the opportunity may never surface.

I claim:

1. A computerized method being used in social and/or business settings where relations are sought after based on known prospects and a set of expectations; while prospects will not know users' intentions unless the intentions are mutual and expectations are met.

2. A method according to claim 1 wherein a networked databases are used for matching users with mutual interests in advancing personal and/or business relations comprising steps of: registering users by filling in questionnaires containing users' own answers and expectations of the counter parties; by users querying the names and/or email addresses and/or web addresses, among others, of the parties of interest; and by the databases returning positive result when such interest in advancing personal and/or business relations are found to be mutual and expectations of each other are met, and by returning negative result when either the counter party does not address interest in advancing such personal and/or business relations, or the expectations do not match.

3. The method according to claim 2 wherein when in the case of negative result, the counter patty is in no way of knowing as no message will be sent to the counter party in this ease.

4. The method according to claim 2 wherein when in case of positive result, separate messages will be sent to involved parties disclosing only the data allowed for disclosing as individual user has specified in the questionnaires, which may or may not include a digital photograph and/or sensitive business information.

5. The method according to claim 2 wherein the method used refers to networked databases with various sets of fields in various layouts; each layout serves like a questionnaire for members to fill in. For each question, member will be required to have (1) member's own answer (such as Profession=“Biotech”; and (2) member's expectations of the prospects (such as Profession=“Biotech” or “Engineering”, etc.—which can be multiple choices or null value). In a different layout questions may be specific to business information such as revenue, debt, etc. Questionnaires take into consideration professional social behaviors and business studies so to enhance the quality of the matches.

6. A method according to claim 1 wherein hardware such as, among others, handheld cell phones is used to initiate query when a prospect is encountered by a user. In this case of romantic relations settings, when two people encounter and at least one of them initiate the query, they are considered “known prospects”. In such case, users' cell phone numbers instead of names or email addresses, etc, will be emitted to service providers to further trigger the matching script in the databases. The databases may return positive or negative result to the cell phone(s) for the involved parties to take further actions, or not. As the return of the result may take only a few seconds, the relations may be realized in real time at the scene of the encounter.

7. The method according to claim 5 wherein existing technologies of global positioning will be used to calculate physical proximity between the two users. What being claimed here is the use of such technologies in social networking settings where a prospect has been identified before the method of networking is deployed.

8. The method according to claim 5 wherein time and physical proximity will be taken into consideration by the databases so to determine the two queries are likely from two people just encountered. To ensure this is the case, a request for confirmation will be sent to both users before a positive return can be delivered. The users need to confirm that they indeed have sent out a query as a prospect is in sight within certain proximity.

9. A method according to claim 1 wherein hardware such as, among others, a hand held Bluetooth enabled device, such as PDA or notebook pc, is used to initiate query when a prospect is encountered by a user. Such Bluetooth enabled device shall have application that runs database script within such Bluetooth enabled device, in the background. In this case of romantic relations settings, when two people encounter and at least one of them initiate the query, they are considered “known prospects”. In such case, users' data stored in the Bluetooth enabled devices will be exchanged to further trigger the matching script in the databases residing in the Bluetooth enabled devices. The databases, which reside in the Bluetooth enabled device(s) may return positive or negative result to the user(s) for the involved parties to take further actions, or not. As the return of the result may take only a few seconds, the relations may be realized in real time at the scene of the encounter. In the case of negative result, the exchanged data will not reside in the hand held Bluetooth device of the prospect so the prospect will not even notice that a query has occurred.
